(19) United States
(12) Patent Application Publication
(10) Pub. No.: US 2012/0217442 A1
(43) Pub. Date: Aug. 30, 2012

(54) HIGH-TEMPERATURE FURNACE AND METHOD FOR CONVERTING ORGANIC MATERIALS TO SYNTHESIS GAS

(75) Inventor: Peter Jeney, Zug (CH)

(73) Assignee: PYROMEX HOLDING AG, Zug (CH)

(21) Appl. No.: 13/501,597

(22) PCT Filed: Oct. 15, 2009
(86) PCT No.: PCT/EP2009/063481

§ 371 Date: May 11, 2012

(51) Int. Cl. C01B 3/02; B01J 19/00

(52) U.S. Cl. 252/373; 422/198

(57) ABSTRACT

High-temperature apparatus (10) for converting an starting material (M) to a synthesis gas (G) and comprising a feeding device (30) and a rotationally symmetrical furnace pipe (20) having a rotation axis (R). The feeding device (30) conducts the starting material (M) into an inner chamber (I) of the furnace pipe (20), and conveying elements (22) are arranged in the inner chamber (I) of the furnace pipe (20) in order to convey the starting material (M) in the direction of an exit side (A) of the furnace pipe (20). The apparatus (10) comprises an elongate resistance heating (23), which protrudes into the interior (I) of the furnace pipe (20) and which comprises at least one hot zone (H1) and a less hot zone (H2), wherein
the hot zone (H1) follows the less hot zone (H2) as viewed from the entry zone (E), and wherein
the resistance heating (23) is configured such that a temperature that is above 1200° C., is achievable in the inner chamber (I) of the furnace pipe (20).

The invention relates to high-temperature furnaces, which are heated by means of a resistance heating, and to methods for using such furnaces, in order to convert organic materials to synthesis gas. In particular, pipe-shaped furnaces are concerned, which are suited for processing carbon-containing or hydrocarbon-containing starting materials, such as waste materials, recycling material, bio mass and so on.

There are different furnaces, which are heated with induction coils. An example is known from the international patent application having the publication no. WO 09010086 A1. A further example is known from the European patent EP 1495276 B1.

It has arisen that problems with the reliability of such induction furnaces can result, if very high-temperatures occur over a longer time period or if very aggressive materials are converted in the furnace. Oxygen, which escapes from the material to be converted, may corrode the furnace wall, for example. There are thus approaches to avoid that oxygen actually gets into the interior of the furnace. An according example is known from the international patent application having the publication no. WO 09010100 A1. Sulphurous and chloric materials are, however, still more aggressive. Sulphur and chlorine are frequent ingredients of organic materials, e.g. when recycling material or the like are concerned.

The present invention concerns providing furnaces, which offer an improved stability against aggressive materials also at high-temperatures. In addition, an efficient conversion of carbonaceous starting materials to a synthesis gas is concerned. The synthesis gas may comprise a portion of methane gas, depending on the process control.

A high-temperature apparatus according to the invention, which is designed for converting a starting material, comprises a feeding device and a rotationally symmetric furnace pipe comprising a rotation axis. Using the feeding device, the organic starting material can be conducted into an inner chamber of the furnace pipe at an entry side. Conveying elements are arranged in the inner chamber of the furnace pipe for conveying the starting material by a rotatory movement of the furnace pipe about the rotation axis in the direction of an exit side of the furnace pipe. The high-temperature apparatus comprises an elongate resistance heating, which protrudes from the exit side of the furnace pipe into the interior of the furnace pipe and which comprises at least one hot zone and a less hot zone. The hot zone follows the less hot zone as viewed from the entry side. The resistance heating is designed according to the invention such that a temperature that is above 1200° C. can be achieved in the inner chamber of the furnace pipe in the region of the hot zone.

The method according to the invention is characterized in that a conversion of organic starting materials to a gaseous product occurs in a high-temperature apparatus. This conversion proceeds progressively in the inner chamber of the furnace pipe of the high-temperature apparatus. The starting material is conducted into the inner chamber at an entry side. The furnace pipe is rotated about a rotation axis for being able to convey the starting material in the inner chamber from the entry side to an exit side. An elongated resistance heating arranged in the inner chamber is operated such that a hotter zone appears following a less hot zone as viewed from the entry side. According to the invention, the starting material proceeds during the conveying through the inner chamber and during the conversion a first temperature zone having an operating temperature between 800° C. and 1000° C., which is followed by a second temperature zone having an operating temperature above 1200° C. and a third temperature zone having an operating temperature which is approximately 10% to 40% below the operating temperature of the second temperature zone.

In the following, the invention is explained on the basis of embodiment examples and with reference to the appended drawings. It shows:

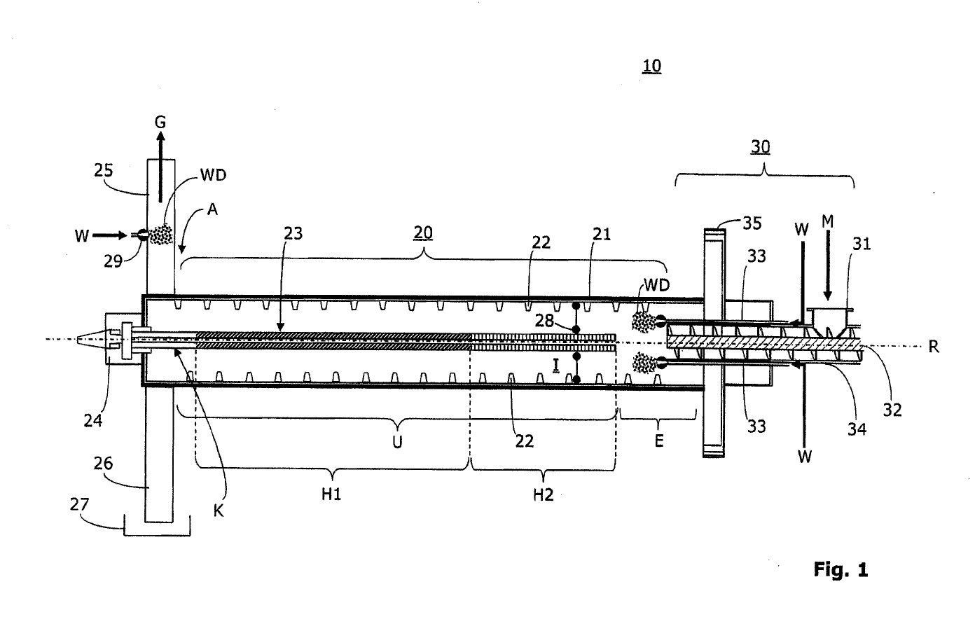

FIG. 1 a schematic cross-sectional view of a preferred embodiment of a high-temperature apparatus according to the invention;

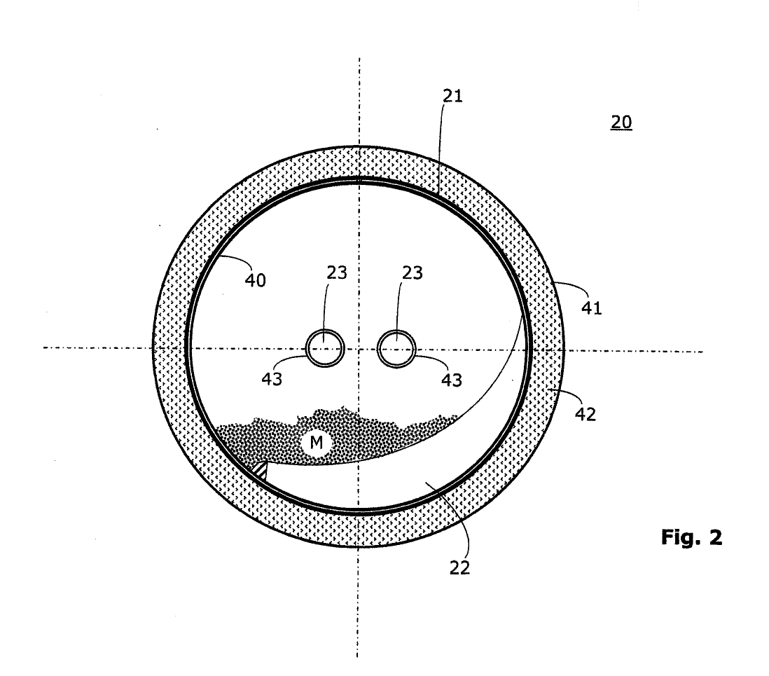

FIG. 2 a schematic cross-sectional view of a particularly preferred embodiment of a high-temperature apparatus according to the invention;

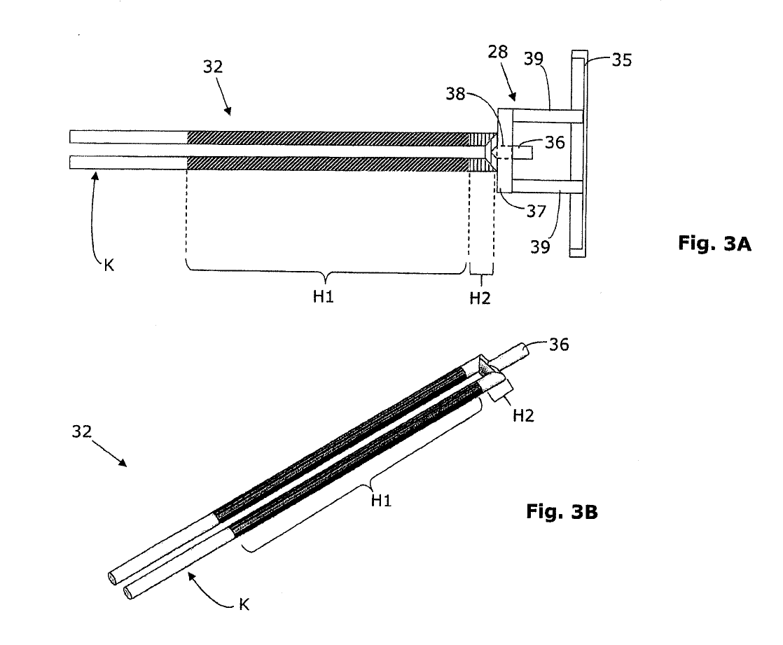

FIG. 3A a schematic view of a preferred embodiment of a resistance heating according to the invention and comprising a bearing;

FIG. 3B a perspective view of the resistance heating according to FIG. 3A; and

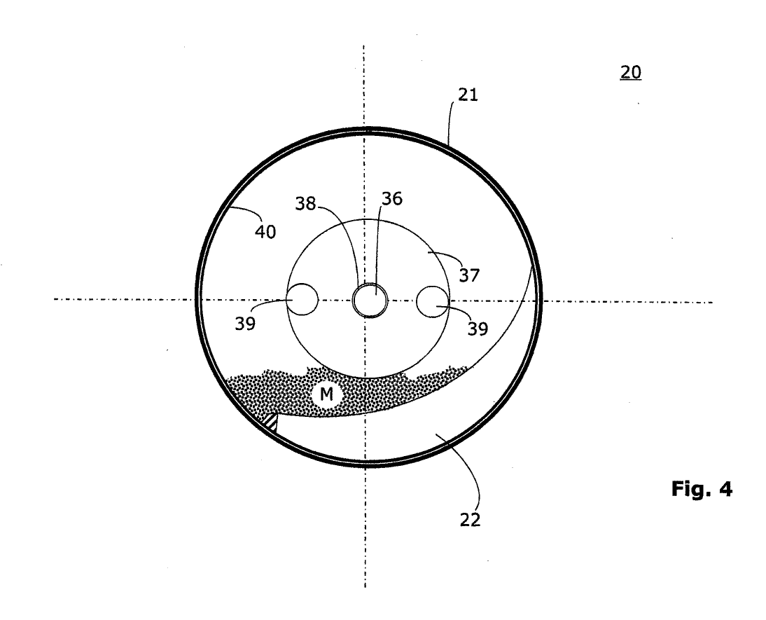

FIG. 4 a schematic cross-sectional view of a further preferred embodiment of a high-temperature apparatus according to the invention.

Statements of places and directions are used in the following in order to be able to better describe the invention. These statements refer to the particular installation situation and shall therefore not be understood as a limitation.

The invention concerns the processing, respectively the conversion of organic starting materials, i.e. carbon-containing or hydrocarbon-containing starting materials, such as waste materials, recycling materials, biomass and the like. In this processing respectively conversion, at least one gas G is generated. Preferably, a synthesis gas is generated, which comprises carbon-monoxide CO and hydrogen H₂. The synthesis gas may comprise a portion of methane gas, depending on the process control.

In the following, details of the invention are explained on the basis of a preferred embodiment and with reference to FIG. 1. Further embodiments are derived from this preferred embodiment. A cross-section through a particularly preferred embodiment is shown in schematized form in FIG. 2.

The high-temperature apparatus 10 according to the invention is designed particularly for converting an organic starting material M. The high-temperature apparatus 10 comprises a feeding device 30 and a rotationally symmetrical furnace pipe 20 having a rotation axis R. The rotation axis R is typically arranged horizontally or slightly inclined. The inclination angle may amount up to 45 degrees in an inclined arrangement. In an inclined arrangement, at least the furnace pipe 20 is arranged obliquely, wherein the exit side A lies higher than the entry zone E. However, the horizontal alignment of the rotation axis R is preferred, as shown in FIG. 1.

Using the feeding device 30, the starting material M can be supplied at the entry side into the entry zone E in the inner chamber I of the furnace pipe 20. Since in most cases the starting material concerns solid matter, the feeding device 30 preferably comprises a screw conveyor 32 which rotates in a conveyor pipe 34. The screw conveyor 32 has a rotation axis which may coincide with the rotation axis R. The rotation axis of the screw conveyor 32 may, however, also be shifted parallel to the rotation axis R, or the rotation axis may stand obliquely with respect to the rotation axis R.

A flange 31 may, for example, be arranged at the conveyor pipe 34 at the upper side for bringing in the starting material M. In the example shown, the starting material M falls from the upper side onto the screw-conveyor 32 and is conveyed into the entry zone E to the left hand side. Here, the conveyor pipe 34 opens into the inner chamber I of the furnace pipe 20, as shown.

Conveying elements 22 are arranged in the inner chamber I of the furnace pipe 20, in order to convey the starting material M in the direction of the exit side A of the furnace pipe 20 when performing a rotational movement of the furnace pipe 20 about the rotation axis R. Preferably, as shown in FIG. 1, a volution 22 sits at the inward facing side of the wall 21 of the furnace pipe 20. A section of such a volution 22 is shown in FIG. 2. However, also plural volutions 22 may be arranged in the furnace pipe 20. Thus, in FIG. 1 the starting material is conveyed from the right hand side to the left hand side. During this conveying to the left hand side, the starting material M undergoes a conversion to a gas G. Though the conversion starts already close to the entry zone E, the intermediate products are referred to in the following still as starting material for reasons of simplicity.

The high-temperature apparatus 10 comprises an elongated resistance heating 23 which protrudes from the exit side A of the furnace pipe 20 into the inner chamber I of the furnace pipe 20. The resistance heating 23 has at least one hot zone H1 and one less hot zone H2. In FIG. 1, the hot zone H1 is indicated by a dense oblique hatching of the resistance heating 23 and the less hot zone can be recognized on the basis of a less dense vertical hatching. As viewed from the entry zone E, the hot zone H1 follows the less hot zone H2, i.e. the entry zone E changes over to the less hot zone H2, which changes over to the hot zone Hl. The resistance heating 23 is designed such that an (operating) temperature in the inner chamber I of the furnace pipe 20 that is above 1200° C. can be achieved in the region of the hot zone Hl. A temperature in the range of 1300° C. (±10%) is particularly preferred here.

In a preferred embodiment, the resistance heating 23 has two legs which extend parallel and which may be arranged one above the other, as shown in FIG. 1. It is also possible to arrange the legs running parallel beside each other, as shown in FIG. 2. This approach is preferred, because the material to be converted is located in the lower section of the furnace pipe 20, as indicated in FIG. 2. Using an arrangement horizontally beside each other, the starting material M is heated more homogenously.

The resistance heating 23 may, however, comprise only one or even three legs. In case two or three legs are present, these run parallel to each other without touching each other. The legs are lead together mechanically and electrically only in the exit side section, i.e. at the exit side A.

In a preferred embodiment, the high-temperature apparatus 10 has a resistance heating 23 comprising silicon carbide (SiC). Preferably, granular silicon carbide is concerned, which has been sintered or molten and cast in the shape of a tube or a bar. Silicon carbide is particularly suitable as a resistance material, because it is capable to achieve temperatures that are lie significantly above 1300° C. by current flow. In addition, it has turned out that silicon carbide is attacked hardly or not at all by aggressive materials which may be generated in the inner chamber I.

In order to be able to achieve a multi-stage conversion of the starting material M according to the invention, a resistance heating 23, which comprises two or more heating zones H1, H2, is preferably employed. An embodiment of the resistance heating 23 comprising two heating zones H1, H2 is shown in FIG. 1.

Very particularly preferred is an embodiment of the resistance heating 23 which comprises a so-called cold zone K (represented white in FIG. 1) at the exit side end. This cold zone K enables to lead the resistance heating 23 through a front wall of the pipe 20 to the exterior and to feed it with current there from the exterior side. An embodiment of the resistance heating 23 is particularly preferred, which comprises a water-cooled connection section 24 at the exit side end. The water cooling enables on one hand a better decoupling of the temperatures of the elements, which are arranged exterior of the furnace pipe 20, and on the other hand side, the water cooling avoids the escape of gas G. That is, the water cooling also serves as a seal.

A preferred embodiment of a resistance heating 23 according to the invention and comprising a bearing 28 is shown in FIGS. 3A and 3B. In this preferred embodiment, the resistance heating 23 comprises two legs running parallel, which may be arranged one over the other as shown in FIG. 1. However, the legs may also be arranged beside each other for example. The legs are lead together mechanically and electrically in the exit side section, i.e. at the exit side A. In the section of the entry zone E, the legs are lead together mechanically. Preferably, the resistance heating 23 is supported by a radial bearing 28 at one position such that compensation movements of the resistance heating 23 parallel to the rotation axis R (i.e. in the axial direction parallel to the rotation axis R) are possible. The radial bearing 28 shown in FIG. 3A supports the one or plural bars of the resistance heating 23 with respect to a non-rotating front wall 35. To this end, a central end spigot 36 may be arranged at the resistance heating 23 in a bearing (e.g. in a bearing bushing 38) of a disc-shaped plate 37. This embodiment of the bearing is designed such that the resistance heating 23 together with the end spigot 36 may perform compensation movements in the longitudinal direction caused by the temperature. Preferably, a ceramic sponge is employed in the section of the bearing bushing 38, in order to provide an elastic soft bearing. The disc-shaped plate 37 may be fixed at a front wall 35, which does not rotate, for example using two spigots 39 extending axially.

A schematic cross-sectional view of a further preferred embodiment of a high-temperature device according to the invention is shown in FIG. 4. The disc-shaped plate 37 comprising an end spigot 36 that is supported axially movably in a bearing bushing 38 can be seen in FIG. 4.

In order to achieve the desired multi-zonal design of the resistance heating 23, the resistance heating 23 has a higher resistance in the section of the hot zone H1 than in the section of the less hot zone H2. This may be achieved preferably in that the one/the plural legs of the resistance heating 23 are provided in the less hot zone H2 with a coating which reduces the effective resistance.

Preferably, the resistance heating 23 is supported at least at one position in the inner chamber I of the furnace pipe 20 in a radial bearing 38 such that compensation movements of the resistance heating 23 parallel to the rotation axis R (i.e. in the axial direction) are possible. Such compensation movements may occur due to thermal expansions, for example. Preferably, the radial bearing 28 is arranged in the section of the less hot zone H2 and/or in the cold zone K. The radial bearing 28 shown supports the one or plural bars of the resistance heating 23 with respect to the inner wall of the furnace pipe 20. In another embodiment, a bearing is employed, which abuts on the front side end of the furnace pipe 20 in the section of the entry zone E. This bearing comprises an elongation element, so that the bars of the resistance heating 23 may expand or contract with respect to the front wall.

The resistance heating 23 made of silicon carbide is relatively brittle and may therefore be damaged easily. In addition, owing to circumstances, aggressive materials (e.g. intermediate products which are generated from the starting material A) may attack the silicon carbide due to its granularity or porosity. It has proven to be particularly useful according to the invention to cover the resistance heating 23 at least in the hot zone H1, with a glass-like ceramic material. Ceramic materials similar to diamond are particularly suitable, which may be vapour-deposited or precipitated from a gas. In FIG. 2, an embodiment of a resistance heating 23 comprising two legs, which are coated with a thin ceramic layer 43, is shown.

In a preferred embodiment, the furnace pipe 20 may also be coated with a glass-like ceramic material (called inner coating 40) at least in the hot zone H1 at the interior and/or on the external side (see FIGS. 2 and 4). Preferably, the same ceramic material 43 is employed as the inner coating 40, which has also been employed for coating the resistance heating 23. Preferably, the whole furnace pipe 20 is coated with a ceramic material on the interior side and the external side.

If the conversion of organic starting materials M is concerned, then a water or vapour feeding device 33 is arranged in the section of the entry zone E, in order to be capable to supply water or water vapour W into the interior I of the furnace pipe 20. The embodiment according to FIG. 1 has two water or vapour feeding lines comprising nozzles (which are called here in their totality water or vapour feeding device 33). In FIG. 1, the water vapour WD that is generated is indicated by two small “vapour clouds”.

The high-temperature apparatus 10 is preferably designed such that in the section of the exit side A, preferably in the section of a gas discharge 25, an additional water or vapour feeding device 29 is arranged in order to be able to supply water or water vapour W. Optionally, a nickel-grid (not shown in FIG. 1) can be arranged in this section in order to stabilize a methane gas or in order to increase the portion of methane gas in the synthesis gas G, which [portion] may be generated at the exit side of the apparatus 10.

A material discharge 26, which may e.g. open into a collection section 27 for receiving solid materials that are expelled from the furnace pipe 20 may be conceived at the exit side A. In the section of the material discharge 26, oxygen may optionally be supplied (not shown in FIG. 1) in order to initiate a (post-) oxidation. Preferably, a so-called gas catcher is realized as a stationary element at the exit side. The furnace pipe 20 is supported rotatably in this gas catcher, whereby the material discharge 26 is directed in the direction of fall and the gas discharge 25 is directed upwardly.

The high-temperature apparatus 10 is preferably designed such that three temperature zones arise during operation, which line up one after the other from the entry side E to the exit side A as follows:
a first temperature zone having an operating temperature between 800° C. and 1000° C. The operating temperature in the first temperature zone preferably amounts to 850° C. (±10%).
a second temperature zone having an operating temperature above 1200° C., preferably an operating temperature of 1300° C. (±10%).
a third temperature zone having an operating temperature that is approximately 10% to 40% below the operating temperature of the second temperature zone. The operating temperature in the third temperature zone preferably amounts to 1000° C. (±10%).

The method according to the invention is designed particularly for converting a solid organic starting material M to a gaseous product G in a high-temperature apparatus 10. The conversion occurs progressively in the inner chamber I of the furnace pipe 20 of the high-temperature apparatus 10.

According to the invention, a starting material M is brought into an entry zone E in the inner chamber I at the entry side. The furnace pipe 20 is rotated at least temporarily (preferably continuously) about the rotation axis R in order to convey the starting material M in the inner chamber I temporarily resp. stepwise or continuously from the entry zone E to the exit side A. Simultaneously, an elongated resistance heating 23 located in the inner chamber I is operated (i.e. supplied with current), so that a hotter zone H1 arises following a less hot zone H2 as viewed from the entry zone E. The starting material M proceeds during the conveying through the inner chamber I, and during the conversion through a first temperature zone having an operating temperature between 800° C. and 1000° C., which is followed by a second temperature zone having an operating temperature above 1200° C. and a third temperature zone having an operating temperature that is approximately 10% to 40% below the operating temperature of the second temperature zone.

The method respectively the apparatus 10 are preferably operated such that an equilibrium state or an equilibrium phase consisting of CO and H₂O arises in the first temperature zone. Thereby, the operating temperature in the first temperature zone amounts preferably to about 850° C. (±10%). Water or water vapour W can be supplied into the first temperature zone, if needed.

The method respectively the apparatus 10 are preferably operated such that the second temperature zone concerns an ultra-high-temperature zone, the operating temperature of which is in the range of about 1300° C. (±10%). Here, a complete purification of gaseous intermediate products results, which are generated from the starting material M upon proceeding through the furnace 20. In particular, tar or tar-containing materials are removed here.

The method respectively the apparatus 10 are preferably operated such that the third temperature zone concerns a stabilizing zone, the operating temperature of which is approximately 10% to 40% below the operating temperature of the second temperature zone. Preferably, the operating temperature of the second temperature zone is above 1200° C.

According to the invention, water or water vapour W can be supplied in the section of the exit side A. In FIG. 1, an according water or vapour feeding device 29 is shown by way of example.

According to the invention, a synthesis gas which comprises essentially carbon monoxide (CO) and hydrogen (H₂) is discharged as a gaseous product G in the section of the exit side A. However, also a portion of methane or methane-containing gas may be generated using the apparatus.

In a preferred embodiment, the pipe 20 rests in a second pipe (called outer pipe 36), which has a greater diameter, as shown in FIG. 2. The intermediate chamber between the pipe 20 arranged inside and the outer pipe 41 is preferably provided with an insulation 42. Thus, the heat insulation to the outside is improved. If an inert gas is employed in the outer pipe 36, then the environment of the apparatus 10 is also better protected against a discharged gas.

The apparatus 10 is long-term stable and reliable. The energy consumption for heating the pipe 20 by means of the resistance heating 23 is significantly lower than in the previous induction heatings. In addition, the local temperature impact and the impact by the strong magnetic flux in the wall 21 of the furnace 20 are significantly lower than for an induction heating.

### LIST OF REFERENCE NUMERALS

apparatus 10
furnace pipe 20
wall 21
conveying elements 22
heating element 23
water-cooled connection section 24
gas discharge 25
material discharge 26
collection section 27
axial bearing 28
water or vapour feeding device 29
feeding device 30
flange 31
conveyor screw 32
water or vapour feeding device 33
conveyor pipe 34
front wall 35
end spigot 36
plate 37
bushing bearing 38
spigot 39
interior coating 40
outer pipe 41
insulation material 42
ceramic layer 43
exit side A
entry zone E
gas G
inner chamber of the furnace pipe 20 I
cold zone K
starting material M
rotation axis R
conversion zone U
water or water vapour W
water vapour WD

1-17. (canceled)

18. High-temperature apparatus (10) for converting an organic starting material (M) to a synthesis gas (G), wherein the high-temperature apparatus (10) comprises a feeding device (30) and a rotationally symmetrical furnace pipe (20) having a rotation axis (R), wherein the starting material (M) is feedable by the feeding device (30) into an inner chamber (I) of the furnace pipe (20) in the region of an entry zone (E), and wherein conveying elements (22) are arranged in the inner chamber (I) of the furnace pipe (20) for conveying the starting material (M) to an exit side (A) of the furnace pipe (20), characterized in that
a rotary motion of the furnace pipe (20) about the rotation axis (R) causes the conveying of the starting material (M) in the direction of the exit side (A) of the furnace pipe (20),
the high-temperature apparatus (10) comprises an elongate resistance heating (23), which protrudes from the exit side (A) of the furnace pipe (2) into the interior (I) of the furnace pipe (20) and which comprises at least one hot zone (H1) and a less hot zone (H2), wherein for this purpose the resistance heating (23) has a greater resistance in the region of the hotter zone (H1) than in the region of the less hot zone (H2), and wherein the hot zone (H1) follows the less hot zone (H2) as viewed from the entry zone (E), and wherein
the resistance heating (23) is configured such that an operating temperature that is above 1200° C. is achievable in the inner chamber (I) of the furnace pipe (20) in the region of the hot zone (H1).

19. High-temperature apparatus (10) according to claim 18, characterized in that the resistance heating (23) comprises two legs running parallel.

20. High-temperature apparatus (10) according to claim 18, characterized in that the resistance heating (23) comprises silicon carbide (SiC).

21. High-temperature apparatus (10) according to claim 18, characterized in that the resistance heating (23) comprises two or more heating zones (H1, H2).

22. High-temperature apparatus (10) according to claim 18, characterized in that the resistance heating (23) is supported in a radial bearing (28) at least at one position in the inner chamber (I) of the furnace pipe (20) such that compensation motions of the resistance heating (23) parallel to the rotation axis (R) are possible.

23. High-temperature apparatus (10) according to claim 18, characterized in that the resistance heating (23) is coated with a glass-like ceramic material (43) at least in the hot zone (H1).

24. High-temperature apparatus (10) according to claim 18, characterized in that the furnace pipe (20) is coated interiorly and externally with a glass-like ceramic material (43) at least in the hot zone

25. High-temperature apparatus (10) according to claim 18, characterized in that a water or vapour feeding device (33) is arranged in the region of the entry zone (E) in order to be capable of supplying water or water vapour (W) into the interior (I) of the furnace pipe (20).

26. High-temperature apparatus (10) according to claim 18, characterized in that a water or vapour feeding device (29) is arranged in the region of the exit side (A), preferably in the region of a gas exit (25) in order to be capable of supplying water or water vapour (W).

27. High-temperature apparatus (10) according to claim 18, characterized in that the high-temperature apparatus (10) is configured such that in operation, three temperature zones are lined up as follows:
a first temperature zone having an operation temperature between 800° C. and 1000° C.;
a second temperature zone having an operation temperature above 1200° C.;
a third temperature zone having an operation temperature that is approximately 10% to 40% below the operation temperature of the second temperature zone.

28. Method for converting an organic starting material (M) to a gaseous product (G) in a high-temperature apparatus (10), wherein the conversion proceeds progressively in the inner chamber (I) of a furnace pipe (20) of the high-temperature apparatus (10), characterized in that the method comprises the following steps:
feeding the starting material (M) n the region of an entry zone (E) into the inner chamber (I) i,
turning the furnace pipe (20) about a rotation axis (R) in order to convey the starting material (M) in the inner chamber (I) from the entry zone (E) to an exit side (A),
operating an elongated resistance heating (23) arranged in the inner chamber (I) such that, as viewed from the entry zone (E), a hotter zone (H1) following a less hot zone (H2) arises,
wherein during the conveying through the inner chamber (I) and during the conversion, the starting material (M) proceeds through a first temperature zone having an operating temperature between 800° C. and 1000° C., which is followed by a second temperature zone having an operating temperature above 1200° C. and a third temperature zone having an operating temperature that is approximately 10% to 40% below the operating temperature of the second temperature zone.

29. Method according to claim 28, characterized in that water or water vapour is supplied into the first temperature zone.

30. Method according to claim 28, characterized in that the second temperature zone concerns an ultra-high-temperature zone, the operating temperature of which is the range of about 1300° C.

31. Method according to claim 28, characterized in that the third temperature zone concerns a stabilization zone, the operating temperature of which is the range of about 1000° C.

32. Method according to claim 28, characterized in that water or water vapour (W) is supplied in the region of the exit side (A).

33. Method according to claim 28, characterized in that a synthesis gas is delivered in the region of the exit side (A) as a gaseous product (G) which comprises substantially carbon monoxide (CO) and hydrogen (H₂).

34. High-temperature apparatus (10) according to claim 19, characterized in that the resistance heating (23) comprises silicon carbide (SiC).

35. High-temperature apparatus (10) according to claim 19, characterized in that the resistance heating (23) comprises two or more heating zones (H1, H2).

36. Method according to claim 29, characterized in that the second temperature zone concerns an ultra-high-temperature zone, the operating temperature of which is the range of about 1300° C.

37. Method according to claim 29, characterized in that water or water vapour (W) is supplied in the region of the exit side (A).
